(19) United States
(12) Patent Application Publication
(10) Pub. No.: US 2024/0013088 A1
(43) Pub. Date: Jan. 11, 2024

(54) COLD ECHO QUBIT SYSTEM AND METHOD OF OPERATION

(71) Applicants: COLORADO SCHOOL OF MINES, Golden, CO (US); CITY UNIVERSITY OF NEW YORK, New York, NY (US)

(72) Inventors: Eliot KAPIT, Golden, CO (US); Vadim OGANESYAN, New York, NY (US)

(21) Appl. No.: 18/347,263

(22) Filed: Jul. 5, 2023

Related U.S. Application Data
(60) Provisional application No. 63/358,425, filed on Jul. 5, 2022.

(51) Int. Cl. G06N 10/70; G06N 10/40

(52) U.S. Cl. CPC G06N 10/70; G06N 10/40

(57) ABSTRACT

Describe herein are various embodiments of protected small logical qubit architectures and superconducting devices for use therewith. The disclosed architectures, methods, devices, and systems, using their most coherent component parts as a baseline, may be useful in suppress all single qubit error channels, and once calibrated can be operated in a fully autonomous manner with no measurement or feedback. Applicant's logical qubit may be compatible with strong, tunable interactions so that fast gates can be performed. In many embodiments, the control structure may be both simple, and robust. In many embodiments, the disclosed methods, devices, and systems are able to endure small variations in the device parameters, to ensure repeatability and scalability.

### CROSS-REFERENCE TO RELATED APPLICATIONS

This application claims benefit of priority pursuant to 35 U.S.C. § 119(e) of U.S. provisional patent application No. 63/358,425 entitled “COLD ECHO QUBIT SYSTEM AND METHOD OF OPERATION,” filed on 5 Jul. 2022, which is hereby incorporated by reference in its entirety.

### FIELD

The disclosed processes, methods, and systems are directed to superconducting logical qubit architectures, devices, systems, and methods of using same.

### SUMMARY

The present disclosure includes examples of superconducting logical qubit architectures, referred to as cold echo qubit (CEQ), which may be capable of preserving quantum information for much longer timescales than any of its component parts. The CEQ may operate fully autonomously, may not require any measurement or feedback, and may be compatible with strong interaction elements to allow for very fast, high fidelity logical gates between multiple CEQs. A CEQ may be constructed using two or more superconducting flux qubits. The two or more superconducting flux qubits may include capacitively shunted flux qubits geometric-inductance flux qubits, double-charge quantum dots, fluxonium devices, or more complex devices. Other types of superconducting flux qubits may be used without departing from the scope of the disclosure.

### BRIEF DESCRIPTION OF THE DRAWINGS

FIG. 1 depicts a schematic circuit diagram of an example fluxonium qubit in accordance with embodiments of the disclosure.

FIG. 2 depicts a schematic diagram of a 2-qubit CEQ circuit having two fluxonium qubits of FIG. 1 coupled together via an inductor circuit, in accordance with embodiments of the disclosure.

FIG. 3 depicts a schematic diagram of a 3-qubit CEQ circuit having three fluxonium qubits of FIG. 1 arranged in a ring, with each pair coupled together via a respective inductor circuit, in accordance with embodiments of the disclosure.

FIG. 4 depicts a schematic diagram of a 2-qubit CPHASE/CZ gate having a pair of 3-qubit CEQ circuits of FIG. 3 coupled together via a flux-tunable ZZ coupling, in accordance with embodiments of the disclosure.

FIG. 5 are graphs showing predicted error rates and logical lifetimes for parameters appropriate to strongly interacting, capacitively shunted flux qubits with large persistent currents.

FIG. 6 are circuit diagrams for the cold echo qubit.

FIG. 7 graphs of predicted error rates and logical lifetime T_{L}.

FIG. 8 is a table, Table I.

### DETAILED DESCRIPTION

Disclosed herein are novel superconducting logical qubit architectures, which may be referred to as a Cold Echo Qubit (CEQ). The CEQ, in many embodiments, is capable of preserving quantum information for much longer timescales than any of its component parts. The CEQ may also operate nearly or fully autonomously, requiring little or no measurement or feedback, and may be compatible with strong interaction elements, allowing for, in some embodiments, very fast, high fidelity logical gates between multiple CEQs. Although not limited to all such implementations, it may be built using some conventional superconducting qubit architecture components, and can be implemented with a wide array of qubit types as its base components. Its quantum state is protected by a combination of strong interactions and microwave driving, which implements a form of many-body dynamical decoupling to suppress phase noise. Estimates based on careful theoretical analysis and numerical simulations predict improvements in lifetimes and gate fidelities by an order of magnitude or more compared to the current state of the art, assuming no improvements in base coherence.

This disclosure includes examples of a superconducting logical qubit architecture called the cold echo qubit (CEQ), which may be capable of preserving quantum information for much longer timescales than any of its component parts. The CEQ may operate fully autonomously, may not require any measurement or feedback, and may be compatible with strong interaction elements to allow for very fast, high fidelity logical gates between multiple CEQs. A CEQ may be constructed using two or more superconducting flux qubits. The two or more superconducting flux qubits may include capacitively shunted flux qubits geometric-inductance flux qubits, double-charge quantum dots, fluxonium devices, or more complex devices. Other types of superconducting flux qubits may be used without departing from the scope of the disclosure.

“Cold” in CEQ may refer to strong (e.g., relative to temperature) coupling between qubits and “echo” in CEQ may refer to the application of oscillating signals to suppress noise. That is, the CEQ system architecture may be implemented with strong couplings as often used in quantum annealing systems, and operation of the system may include application of a form of many-body dynamical decoupling to suppress phase noise.

“Echo” in CEQ may refer to oscillating signals applied to the component qubits of the CEQ, to continuously and resonantly drive multi-qubit transitions between the two low energy states of the component qubits. A static-bias field may be applied to the component qubits in the CEQ to define the energy spacing between these multi-qubit states, and the frequencies of the oscillating signals may be chosen such that an integer multiple of them is nearly equal to the chosen bias, creating a resonant transition. The effect of such resonant driving may be used to suppress low frequency phase noise in the CEQ. The combination of strong interactions and this resonant driving may suppress all single qubit error channels, leading to a logical coherence time for the CEQ that is higher than that of any of its component devices.

The strong coupling between qubits may provide faster interactions, because qubit states may flip more rapidly as compared with weak coupling implementations, which may reduce opportunity for introduction of error. The application of oscillating terms may result in what is functionally a single syndrome qubit (e.g., potential error occurring almost entirely along one axis), which is easier to detect and/or correct using larger error correction codes involving multiple copies of the CEQ. The described implementation may improve data retention lifetimes and gate fidelities by an order of magnitude or more compared to the current state of the art.

To achieve the strong coupling between the qubits, the CEQ architecture may include a inductor circuit configured to couple two adjacent qubits together, with the “ground” sides of each qubit directly connected to form a closed loop. In some examples, inductance of the inductor circuit may be fixed. In some examples, the inductor circuit may include a superinductor. In some examples, this inductor may be replaced by a Josephson junction. The inductor circuit may create a strong energy shift between two qubits, which may push them to end up in a common state. That is, a low energy, equilibrium state between two qubits coupled to one another via the inductor circuit of the CEQ system occurs when both qubits are in a common state. If the qubits are in different states, the system is operating in an undesirable, higher energy state. Once in the low-energy, equilibrium state, the amount of energy necessary to flip one of the qubits to a different state is much higher than what it would cost if the two qubits were weakly coupled or not coupled at all.

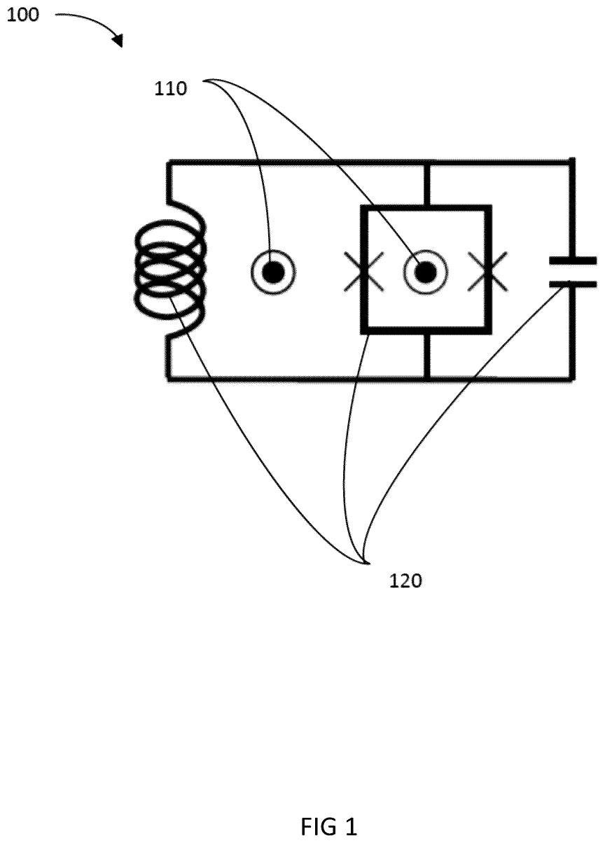

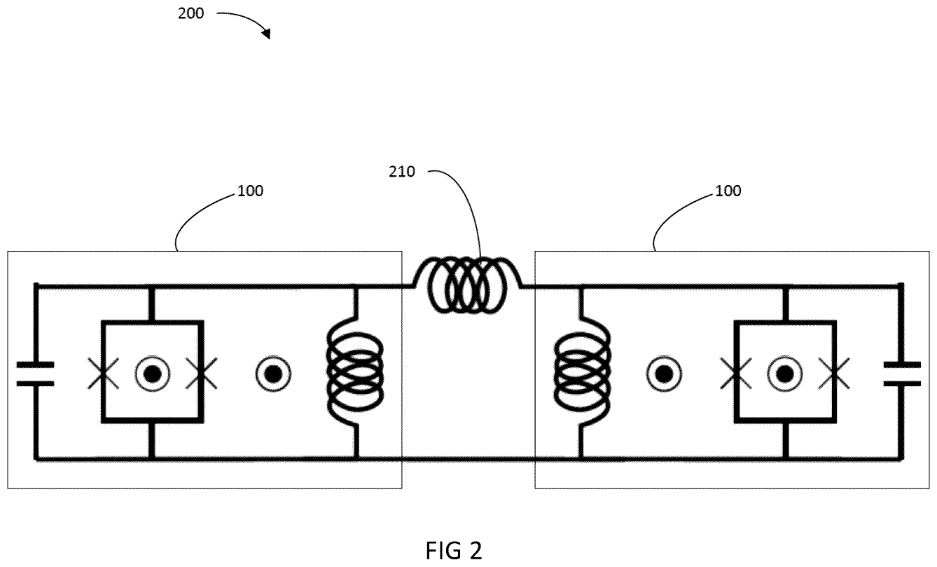

FIG. 1 depicts a schematic circuit diagram of an example fluxonium qubit 100 in accordance with embodiments of the disclosure, and FIGS. 2-4 depict schematic circuit diagrams of example CEQs using the fluxonium qubit 100 of FIG. 1 in accordance with embodiments of the disclosure.

The fluxonium qubit 100 of FIG. 1 may include two threaded fluxes (nested circles) 110 and a superconducting quantum interference device (SQUID) 120 (e.g., represented by the box around the threaded flux, the capacitor, and the inductor). The SQUID 120 may facilitate tuning of the transverse field of the qubit during operation. The magnetic fluxes controlling these elements may be oscillated in time in the CEQ's operation.

FIG. 2 depicts a schematic diagram of a 2-qubit CEQ circuit 200 having two fluxonium qubits 100 of FIG. 1 coupled together via an inductor circuit 210, in accordance with embodiments of the disclosure. In the 2-qubit CEQ circuit 200, there is no flux threaded through the loop created by the coupling (e.g., the inductor circuit 210), because the inductor circuit 210 is linear and any flux in that loop may be compensated in the two fluxonium qubits 100 via the main loop flux controls. The quantum state of the 2-qubit CEQ circuit 200 may be determined based on states of the two individual fluxonium qubits 100. If the states of the two individual fluxonium qubits 100 match (up to small corrections from the transverse fields of the qubits), the quantum state of the 2-qubit CEQ circuit 200 may be that matched state. If the states of the two individual fluxonium qubits 100 do not match, the quantum state of the 2-qubit CEQ circuit 200 may be undetermined. Optionally, the fluxonium qubits in this figure could be replaced by other flux-qubit designs (e.g., a capacitively shunted flux qubit) consistent with this coupling structure. Optionally, the linear inductor connecting the two fluxonium qubits could be replaced with a Josephson junction, with an additional flux threaded through the loop to control the interaction between the two components of the CEQ.

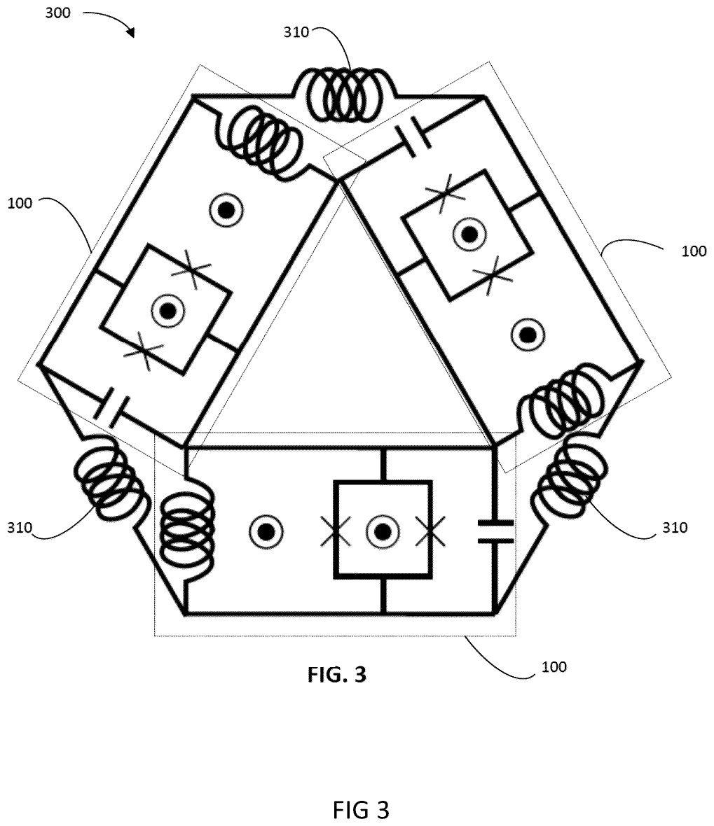

FIG. 3 depicts a schematic diagram of a 3-qubit CEQ circuit 300 having three fluxonium qubits 100 of FIG. 1 arranged in a ring, with each pair coupled together via a respective inductor circuit 310, in accordance with embodiments of the disclosure. Similar to the 2-qubit CEQ circuit 200 of FIG. 2, there is no flux threaded through the loop created by the inductor circuits 310 in the 3-qubit CEQ circuit 300, because the inductor circuits 310 are each linear and any flux in those loop may be compensated in the three fluxonium qubits 100 via the main loop flux controls. The quantum state of the 3-qubit CEQ circuit 300 may be determined based on states of the three individual fluxonium qubits 100. That is, the quantum state of the 3-qubit CEQ circuit 300 may be the state that matches ⅔ or more of the three individual fluxonium qubits 100. As in FIG. 2, optionally, the component qubits and/or inductors coupling them could be replaced with other elements to achieve the same purpose. Optionally, a CEQ constructed from 3 or more component flux qubits could be arranged as a line instead of as a closed ring.

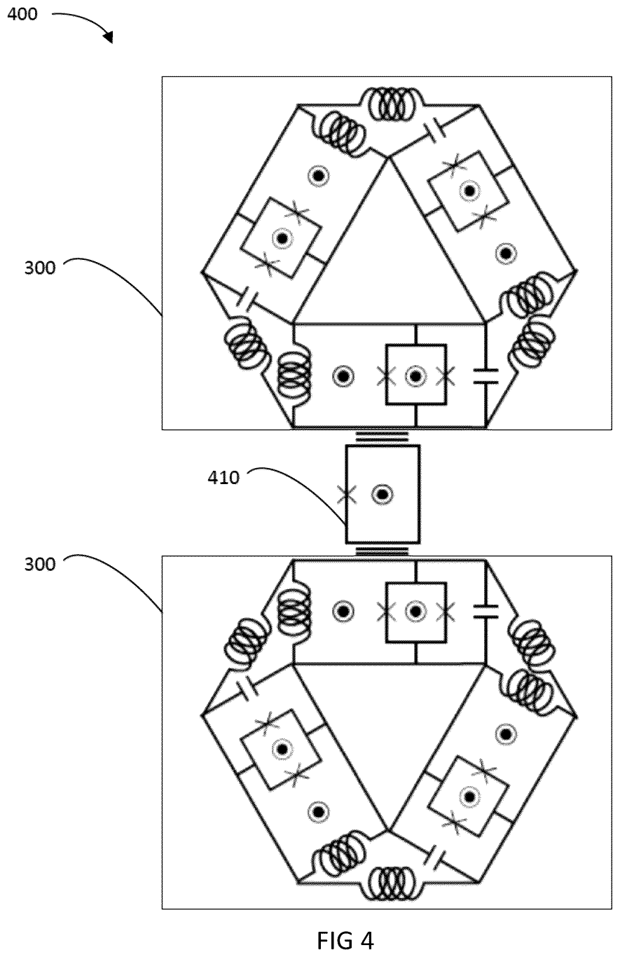

FIG. 4 depicts a schematic diagram of a 2-qubit CPHASE/CZ gate 400 having a pair of 3-qubit CEQ circuits 300 of FIG. 3 coupled together via a flux-tunable ZZ coupling 410, in accordance with embodiments of the disclosure. The coupling between the two 3-qubit CEQ circuits 300 via the flux-tunable ZZ coupling 410 may be weaker than the coupling between the individual fluxonium qubits 100 within each of the two 3-qubit CEQ circuits 300 via the respective inductor circuits 310. The flux-tunable ZZ coupling 410 may be configured to selectively control interactions between the two 3-qubit CEQ circuits 300. This tunable element may be of similar maximum energy to the couplings between component qubits in each CEQ, or may be weaker.

These figures do not depict couplings between the component qubits of the CEQ to additional linear objects, such as superconducting resonators, which are used to measure the state of the CEQ. Each component qubit in a CEQ may be coupled to one or more readout resonators. In some implementations, each component qubit may be coupled to its own, independent readout resonator. In other examples, more than one component qubit may be coupled to a single readout resonator. In yet other examples, some individual component qubits may be coupled to independent readout resonators and other component qubits may be coupled to a shared readout resonator. In some examples, the readout resonator couplings may be controlled using external signals to turn them on and off as a means of reducing noise in the CEQ.

The Examples Section, below, includes various specific, non-limiting examples of the CEQ architecture described herein. The contents of the Examples are disclosed and described for all non-limiting purposes.

### EXAMPLES

Applicants describe herein engineering a protected small logical qubit using superconducting devices, which, using its most coherent component parts as a baseline, suppresses all single qubit error channels, and once calibrated can be operated in a fully autonomous manner with no measurement or feedback. Applicant's logical qubit may be compatible with strong, tunable interactions so that fast gates can be performed. In many embodiments, the control structure may be both simple, and robust. In many embodiments, the disclosed methods, devices, and systems are able to endure small variations in the device parameters, to ensure repeatability and scalability.

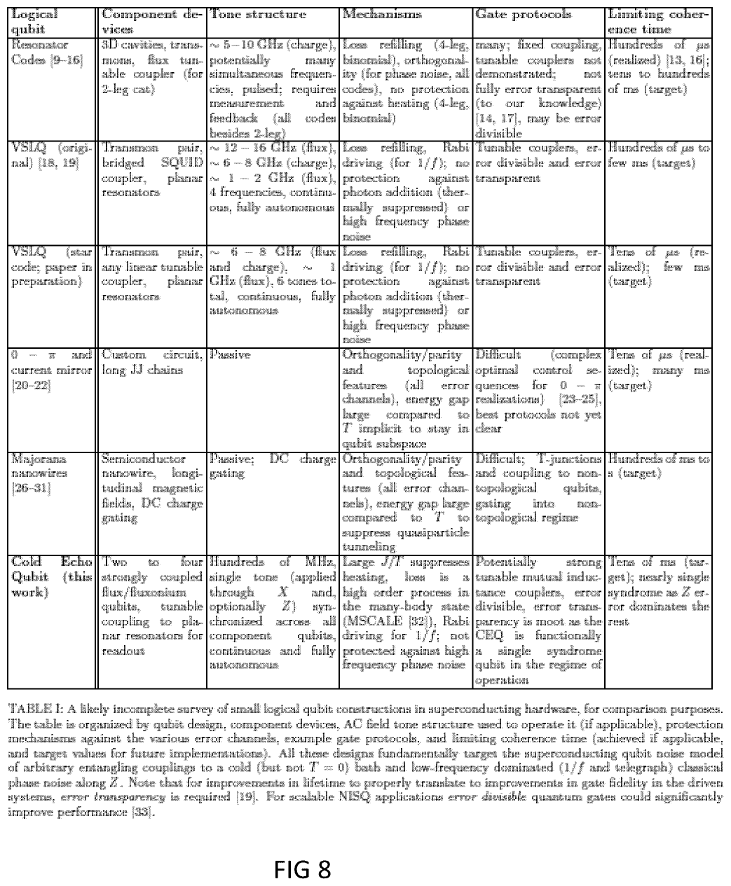

Remarkably, Applicants have surprisingly found that these characteristics can be accomplished with just 2-4 tunable flux qubits (either capacitively shunted flux qubit [1] or fluxonium [2, 3] devices, though other choices, known to those of skill in the art, could work as well), coupled to each other through strong ferromagnetic interactions. Unlike other small logical qubits, this is not an error correction device, but instead protects its collective quantum state against the flux qubit noise model through a combination of interactions that are stronger than the fridge temperature (which suppresses environmental loss errors) and a novel many-body dynamically decoupling scheme (which suppresses phase noise). The phase noise suppression arises from oscillating qubit parameters with an AC flux signal, which can be just a single tone applied to all component qubits, though more complex signal structures are also possible. This tone oscillates the magnitudes of the qubits' transverse fields, and optionally, their z biases as well. Given the combination of mechanisms Applicant refers to this as the Cold Echo Qubit, or CEQ for short. As seen in Table I at FIG. 8, the properties of the CEQ are very different from other small logical qubit designs.

### Conventions

Since the presently described component qubits are flux qubits (formally, any type of flux qubit that quantizes to a Hamiltonian given by double well potential with tunable transverse field and Z bias will work for the present architecture and embodiments, provided that the nonlinearity is large enough that states j2i and higher may, in most cases, be ignored. This includes geometric inductance flux qubits [4], 3-junction flux qubits [5] such as CSFQs, fluxonium devices, and potentially more exotic configurations as well), the following definitions may be adopted. Each qubit is defined by its two persistent current states (clockwise or counterclockwise), which we call |├0)| and |├1) along the Z axis. Their energy splitting is set by the flux bias through the main loop of the qubit. Barrier tunneling, controlled by the qubits' SQUID, generates an X term which splits the degeneracy between the two persistent current states. By convention this term is negative in the Hamiltonian and we let its strength be K. Qubits are coupled to each other by tunable ZZ interactions. We assume the nonlinearities are large enough that we can ignore states |├2) and higher for each component qubit.

### Core Noise Model

The following noise model is assumed for the present devices, inspired by the extremely detailed noise spectroscopy results from MIT:LL [1, 6, 7] on capacitively shunted flux qubits (CSFQs). Every component qubit couples to its environment though a mix of X, Y, and Z couplings, and it is assumed that all of these couplings are generically nonzero, though given the geometry of these devices we empirically expect the Z coupling to be strongest, followed by Y then X. In general, the larger the qubit's persistent current, the larger the Z noise becomes (see [1] for a survey); for fluxonium devices Y error, representing loss into the environment through the charge degree of freedom, is likely largest. These are entangling interactions that exchange energy with a thermal environment at temperature T. Note that this temperature is typically a bit larger than the nominal fridge temperature; for the purposes of this writeup whenever T is mentioned it can be assumed it is the temperature seen by the qubits themselves.

Alongside these bath couplings, each qubit experiences independent, classical 1/f noise along Z, represented by fluctuating terms δhⱼ(t) Zⱼ in the Hamiltonian. In principle there is 1/f noise in the other parameters (e.g. X and ZZ terms) as well, but this is not expected to affect logical qubit performance for reasons that will become clear below. This is the basic noise model common to all superconducting devices [8].

### Basic Theory and Operation

The cold echo qubit consists of a ring of L≤4 qubits, ferromagnetically coupled to each other with ZZ couplings. (For packaging or other reasons, one might want to make an CEQ with open ends, instead of a ring geometry; the analysis here proceeds identically although the energy gap to thermal excitations at the ends of the chain is reduced.) Our Hamiltonian is

$$H = - J {\sum }_{j = 0}^{L - 1} {z}_{j} {z}_{j + 1} - κ {\sum }_{j} {X}_{j} + \frac{h}{2 L} {\sum }_{j} {Z}_{j} \qquad ( Equation 1 )$$

The X and Z fields can and will be tuned dynamically; the ZZ term is fixed to its maximum ferromagnetic value and need not be tunable. We let our (bare) logical states be:

|0_{L}^{bare} [symbol] ≡|0 [symbol] ⊗^{L},|1_{L}^{bare} [symbol] ≡|1 [symbol] ⊗^{L} (Equation 2)

and let |0_{L}) and |1_{L}) be the dressed logical states incorporating perturbative corrections from the transverse field. Starting from Eq. 1, the various terms will be described/reviewed one by one, and how each contributes to noise protection will be discussed.

First let κ=h=0. In this limit the bare states in Eq. 2 are exact, and the system is protected against all local X or Y errors, since those now cost energy 4 J (or 2 J for L=2) and we assume a low temperature T<J. However, there is no protection against dephasing, so any superposition of the two logical states will dephase rapidly from 1/f noise, and the logical lifetime is worse than that of a single component qubit.

Expected coherence with κ=h=0: poor, as there is no suppression of 1/f dephasing.

Now let the transverse field K be nonzero. This creates a many-body tunneling term between the two states, resulting in the following effective Hamiltonian for the logical manifold

$${H}_{eff} = - {Ω}_{0} ( \vert {0}_{L} 〉 〈 {1}_{L} \vert + \vert {1}_{L} 〉 〈 {0}_{L} \vert ) , {Ω}_{0} ∝ \frac{{κ}^{L}}{{J}^{L - 1}} . \qquad ( Equation 3 )$$

For reasons described below, turning on finite K reintroduces relaxation through single qubit X and Y errors, though this is a very weak effect we ignore for the moment. Since the Ω₀ term anticommutes with all local Zⱼ terms, it can strongly suppress the classical 1/f noise; as discussed below, if the base dephasing time is T_{ϕ}, the resulting error rate will scale as 1/(T_{ϕ}²Ω₀), a significant improvement.

However, a new error channel arises from the Ω₀ term in Eq. 3. Specifically, the eigenstates of H_{eff} are |±_{L})≡(|0_{L} [symbol] +|1_{L} [symbol] /\sqrt{2} with energies ±Ω₀. And while 1/f noise is not expected to mix them at reasonable rates, if any of the qubits have Zⱼ couplings to low energy degrees of freedom in the environment, they can exchange energy with it at rates ¬_{z} since the matrix element [symbol] +_{L}|Zⱼ|−_{L})≅1. As we expect these couplings to be present, the logical qubit has lost its protection, and whether or not the resulting logical lifetime exceeds that of a single component qubit depends on the relative values of L¬_{z}, 1/T_{ϕ} and so forth. Because an un-suppressed error channel is present we do not expect the logical qubit to perform well in this limit.

Expected coherence with κ nonzero, h=0: marginal, as 1/f noise is suppressed but dephasing via bath couplings is not.

To remedy this, the detuning h is allowed to be nonzero. Resulting in:

H_{eff}=−Ω₀(|0_{L}) [symbol] 1_{L}|+1_{L}) [symbol] 0_{L}|)+h|1_{L}) [symbol] 1_{L}|. (Equation 4)

If we let h>>Ω₀, the resulting eigenstates are

$$\vert {0}^{′} 〉 ≃ \vert {0}_{L} 〉 + \frac{{Ω}_{0}}{h} \vert {1}_{L} 〉 and \vert {1}^{′} 〉 ≃ \vert {1}_{L} 〉 - \frac{{Ω}_{0}}{h} \vert {0}_{L} 〉 ,$$

separated by an energy difference \sqrt{h²+4Ω₀²}. As (1′|Zⱼ|0′)≅2Ω₀/h, bath-induced mixing can be highly suppressed and all bath-related error rates are now very slow. But since our eigenstates are predominantly Zⱼ eigenstates we have lost our protection against 1/f noise and are seemingly back to where we started.

Letting h>>Ω₀, the resulting eigenstates are

$$\vert {0}^{′} 〉 ≃ \vert {0}_{L} 〉 + \frac{{Ω}_{0}}{h} \vert {1}_{L} 〉 and \vert {1}^{′} 〉 ≃ \vert {1}_{L} 〉 - \frac{{Ω}_{0}}{h} \vert {0}_{L} 〉 ,$$

separated by an energy difference \sqrt{h²+4Ω₀²}. As (1′|Zⱼ|0′)≅2Ω₀/h, bath-induced mixing can be highly suppressed and all bath-related error rates are now very slow. But since the present eigenstates are predominantly Zⱼ eigenstates the present protection against 1/f noise may be lost seemingly returning back to the start.

Expected coherence with static K and h nonzero: poor, as there is once again no suppression of 1/f dephasing. However, the system is now properly quantum and all bath-related error channels are suppressed, so we only have dephasing from classical fluctuations to contend with.

To eliminate this last remaining error channel, we introduce oscillations in the magnitudes of the transverse fields, as in RFQA-M:

$$H ( t ) = - J {\sum }_{j = 0}^{L - 1} {Z}_{j} {Z}_{j + 1} - κ {\sum }_{j} {X}_{j} ( 1 + αsin ( 2 π vt ) ) + \frac{h}{2 L} {\sum }_{j} {Z}_{j} , \qquad ( Equation 5 )$$

where α≤1 is the relative amplitude of the oscillations. (There is no a priori reason why we need to oscillate everything at the same amplitude, frequency and phase. However numerical simulations indicate this choice appears to be best, in terms of producing the largest Ω_{AC} for a given drive strength and frequency, so we choose it for this writeup. So long as at least some combinations of frequencies sum to ˜h the core idea should still work, however.) If we choose (note that it should not be exactly h/n given Stark shifts and perturbative corrections) v to be h/n for integer n, then we can resonantly drive the L-spin transition between states separated by the large energy difference ˜h, and our effective Hamiltonian is:

H_{eff}(t)=−(Ω₀+Ω_{AC} sin(2πht))(|0_{L} [symbol] (1_{L}|+|1_{L} [symbol] [symbol] 0_{L}|)+h|1_{L} [symbol] [symbol] 1_{L}|. (Equation6)

Here, Ω_{AC}∝Ω₀αⁿ, up to prefactors from combinatorics. One can further increase Ω_{AC} by adding oscillating offsets to the Z fields as well, synchronized with the X fields. The Ω_{AC} term drives resonant Rabi flopping between the dressed logical states |0_{L}) and |1_{L}), and thus will suppress 1/f noise. However, unlike the DC transverse field term Ω₀, this AC version does not generate new un-suppressed error channels, because while it can in principle induce bath-assisted transitions as in RFQA [32], per MSCALE all of those transition rates are suppressed by a prefactor of (Ω₀/h)² and thus can be made extremely weak. Critically, unlike in the DC case there is no obvious mechanism by which the AC driven L-spin process can generate relaxation into the bath through Zⱼ terms; Zⱼ couplings to the bath simply do not interact meaningfully with the AC drives. (A simpler, analogous case is that of a single, Rabi-driven qubit such as a CSFQ or transmon; assuming a pure 1/f noise model, when driven hard enough the lifetime T₂ is bounded by twice the relaxation rate T₁. This is because the driving does not meaningfully alter the relaxation rate, and an X eigenstate is scrambled by relaxation at half the rate since it only has a 50% probability of being in the excited state |1) at any time.) And as 1/f noise was our last remaining error channel, by echoing it out with many-body dynamical decoupling we have now successfully suppressed all single qubit error channels.

Expected coherence with κ and h nonzero, and AC driving of L-spin transitions: very high, as all single qubit error is now suppressed by a combination of mechanisms.

Of course, suppressed is not the same as eliminated, and we have introduced a host of parameters without clearly defining their scales, much less how the ultimate coherence depends on them. We now consider them in detail to set expectations for testbed experiments and beyond.

### Predicted Error Channel Scaling

Thermal excitation error is the error rate that results from randomly absorbing energy from the environment, creating single qubit excitations. This is predominantly through the X or Y channels. We set the base error rate for these channels by taking a single component qubit, assigning it an energy E=4 J through a combination of the X and Z fields, and then measuring the relaxation rate into the environment from X or Y operations only—this gives us rates ¬ₓ and ¬_{y}. If we assume a single excitation from the environment is sufficient to scramble the state, then our thermal error rate ¬ₜₕ is given by

$${Γ}_{th} ≃ ( {Γ}_{x} + {Γ}_{y} ) exp ( - \frac{4 J}{T} ) . \qquad ( Equation 7 )$$

Here, ¬ₓ and ¬_{y} are evaluated at an energy E=4 J (2 J for the two-qubit version) and the factor of L comes from the fact that each qubit independently contributes to this error channel.
Low energy environmental error comes from the fact that, due to higher order perturbative corrections, the matrix elements [symbol] 1_{L}|/σⱼ^{x/y/z}|0_{L} [symbol] are all generically nonzero, though they are small. The z contribution to this rate can be straightforwardly read off from perturbation theory—if the nominal relaxation rate through Z to the environment is ¬_{z} (inferred from a single qubit with no Z bias and an X field chosen to set the qubit energy to h, as discussed above), then the logical error rate is

$${Γ}_{Z , le} ≃ 4 L {{Γ}_{z} ( \frac{{Ω}_{0}}{h} )}^{2} . \qquad ( Equation 8 )$$

Note that Ω₀/h enters this equation quadratically, the result of the perturbative matrix element being Ω₀/h and bath error rates being derived from Fermi's Golden Rule (where the interaction is squared). We can similarly infer the corresponding rates from X and Y errors—appealing to the forward approximation, they scale as

$${Γ}_{X / Y , le} ≃ {c}_{x / y} L {{Γ}_{x / y} ( \frac{{Ω}_{0}}{h} )}^{2} , \qquad ( Equation 9 )$$

where c_{x/y} is an O(1) prefactor that can be computed from the dressed logical states |0_{L} [symbol] and |1_{L} [symbol] .
Per the arguments that derive RFQA in larger systems, we also expect contributions to this rate from AC processes, where local oscillating fields drive transitions that exchange energy with bath degrees of freedom at the appropriate (shifted) frequencies. Since we are driving everything at a single frequency and L is small, these do not proliferate exponentially as in RFQA, and are expected to have the same overall scaling as Γ_{X/Y/Z,le} derived above.
1/f-induced dephasing is suppressed by the AC drives. We let the pure dephasing time from 1/f noise be T_{Φ}, measured via Ramsey decay. For a single qubit, Rabi driving it converts the Gaussian decay of 1/f dephasing to simple exponential, and if the Rabi rate Ω is larger than 1/T_{Φ} then the resulting T₂∞T_{Φ}²Ω. Given that excitations from 1/f noise at energies ˜4 J are going to be extremely rare, we simply sum the 1/f traces of each qubit to produce a single fluctuating δh(t), which also has a 1/f spectrum. This leads to an error rate

$${Γ}_{Z , 1 / f} ≃ \frac{L}{5 {T}_{Φ}^{2} {Ω}_{AC}} . \qquad ( Equation 10 )$$

The factor of 5 in the demoninator comes from numerical best fitting and the L in the numerator comes from the phase noise strength scaling as \sqrt{L}, which reduces T_{Φ} by 1/\sqrt{L}, compared to a single qubit.
Readout error is the error in measuring the full cold echo qubit logical state. We assume that when the CEQ is read out all X fields are turned off and everything is measured along the Z axis, the persistent current basis, and assume that the CEQ is in some superposition of logical states prior to initiating readout. Readout error is then given by the (likely very small) probability of exciting out of the logical manifold during the ramp (which will increase linearly with L and decrease exponentially with J/T), plus the error from mis-identifying the state itself. If that error is p per component qubit, then we can decrease mis-identification error exponentially through majority voting, if the number of qubits is larger than L=2. In total, readout error is the sum of the thermal excitation error rate during the ramptime, and the state mis-identification error rate, which decreases as p² for L=3 or L=4 for single qubit measurement error rate p.

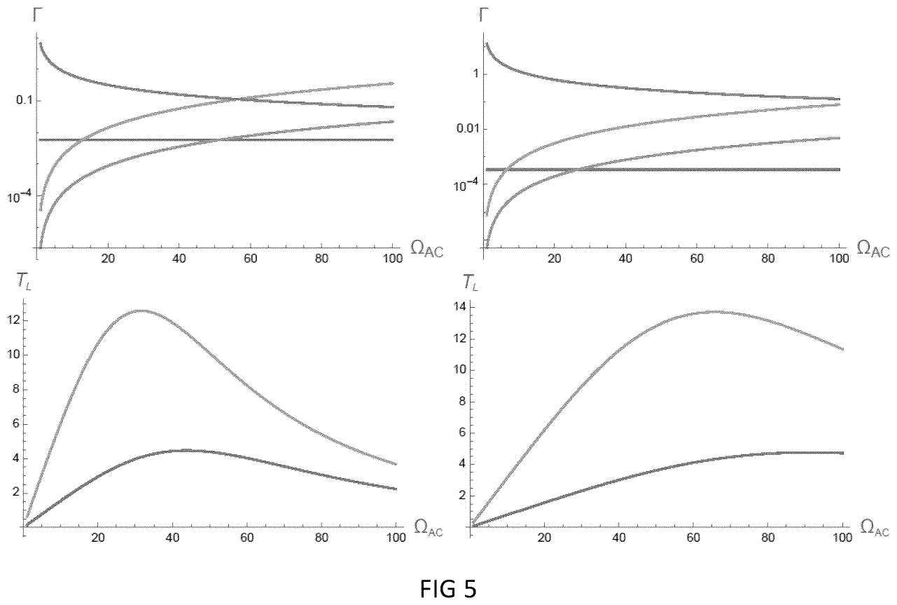

The ultimate performance of the CEQ may be limited by the largest of these error rates, which are plotted for parameters appropriate to large persistent current CSFQ's (as in [33]) in FIG. 5. This is in many ways a worst case for CEQ coherence, but since these devices exist already in labs, one can test the basic mechanisms and operation of the CEQ without needing to fabricate a new device from scratch. J should be made as large as hardware (and the need to avoid any mixing with non-computational states) allows. The detuning h should be made as large as is straightforwardly possible (there's a possible exception here when J/T is not very large, so that the energy shift lowering the excitation cost for one of the states can cause a meaningful increase in Γₜₕ. This is more of a concern for L=2 and likely a marginal effect, but it's worth noting) but is bounded by J, since large detuning requires high frequencies that can cause off-resonant excitations. (This error rate was not included in the itemized list above, because it decreases exponentially in J/h and thus can be made arbitrarily small with ease) Since the transverse field is positive definite in these qubits, Ω_{AC} is approximately equal to Ω₀(numerics indicate for v≅h, we can achieve Ω_{AC}≅(L−1)Ω₀), and as low-energy environmental error increases with Ω₀, one would choose transverse field and drive strengths to suppress T_{Z,1/f}, until it falls below the thermal error rate Γₜₕ (which is constant) or Γ_{X/Y/Z,le} (which is increasing with Ω₀ and thus with Ω_{AC}), whichever comes first.

The optimal value of L, given the reduction in both thermal and readout error, is clearly L=3. However, other considerations such as compactness or the employment of fairly exotic signal structures might favor L=2 or L=4.

FIG. 5: Predicted error rates and logical lifetimes for parameters appropriate to strongly interacting, capacitively shunted flux qubits with large persistent currents. We assume J=2π×1 GHz, T=25 mK, h=2π×300 MHz, Γₓ=0.1, Γ_{Z}=0.4 MHz (corresponding to a 2 μs T₁ at degeneracy) and 1/fT_{Φ}=0.1 Left panels are L=2, right L=4. Top: log-scale plots of Γₜₕ(blue, Γ_{Z,le})(gold), Γ_{X,le}(green) and Γ_{Z,1/f} (red), as a function of Ω_{AC}, assuming Ω₀=Ω_{AC}. Bottom: total logical coherence TL=(Γₜₕ+Γ_{Z,le}+Γ_{X,le}+Γ_{Z,1/f})⁻¹. Blue curves are for the parameters listed, gold for 3 μs T₁ and 0.2 μs T_{Φ}. Notice that optimal lifetime increases super-linearly, particularly with L=4. Ω_{AC} is in MHz (ϕ2π), Γ's are in MHz, T_{L} in μs.

As seen in FIG. 5, the Ω₀ term can often end up being the coherence limit, depending on the value of Γ_{z}. Unfortunately, this term is unavoidable in the short term, since the transverse field is positive definite and if we want to oscillate its magnitude we need to do so around a nonzero value. However, this might not be the case in more exotic qubit designs, or with more clever signal structure—we will leave that consideration to future work.

### Gates

The base gate set of the cold echo qubit consists of single qubit logical X and Z rotations, along with CPHASE/CZ. The drive terms that generate Ω_{AC} causes the logical qubit state to continuously rotate around the X axis, albeit at rates that could be fairly slow given the considerations of the previous section. To do faster X rotations, one can simply increase all the AC drive amplitudes for a short pulse. This will increase Γ_{Z,le} during the gate, but since we expect that rate to be much smaller than Γₜₕ or Γ_{Z,1/f} we should still be able to do fast, high-fidelity operations. There are likely a variety of other ways to achieve fast X rotations but simply pulsing an increase in Ω_{AC} is the most obvious and straightforward. For a near-term demonstration, Ω_{AC} will be larger compared to its value in a future 3-qubit fluxoninum based design (compare the optimal points in FIGS. 1 and 2), so fast X rotations are automatic.

Logical Z rotations can be performed by pulsing the individual Z biases. It may be desirable to momentarily weaken or turn off the Ω_{AC} field generating continuous X rotations during this step. Note that this does not interfere with the 1/f protection if the Z rotations are short (we expect 10-20 ns), since the duration will be so short that any 1/f noise will be sampled at very high frequency as a result, where it is weak.

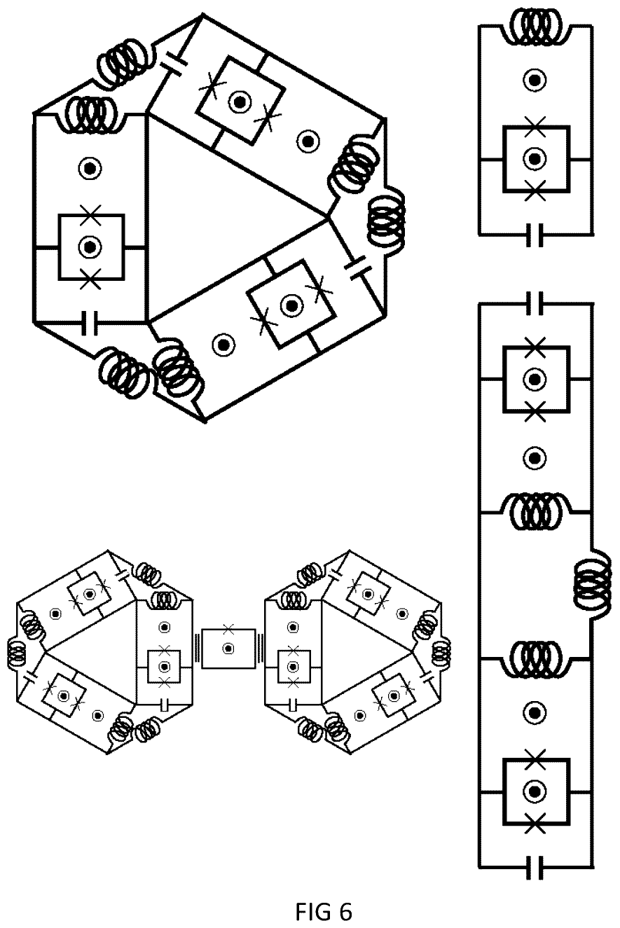

FIG. 6: Circuit diagrams for the cold echo qubit. Top left: a single fluxonium qubit with two threaded fluxes (nested circles) and a SQUID so that its transverse field can be tuned. Top right: L=2 cold echo qubit, coupled by a fixed inductance. Note that there is no flux threaded through the loop created by the coupling, because that element is linear and any flux in that loop can be compensated in the qubits by the main loop flux controls. Bottom left: L=3 cold echo qubit, with couplings arranged in a ring as described in the text. Bottom right: flux-tunable ZZ coupling between a pair of L=3 cold echo qubits, used to implement two-qubit CPHASE/CZ gates.

CZ can be done by simply adjusting the flux-tunable mutual inductance between a pair of logical qubits. As in logical Z rotations we may want to momentarily weaken or disable Ω_{AC} during this step. Note that since the inductive couplings between qubits are quite large, these gates can be done very quickly, much faster than any other superconducting design I'm aware of. Further, unlike transmons, assuming crosstalk is mitigated, no core design reason prevents a single cold echo qubit from participating in multiple CZ gates simultaneously. This is a potentially significant benefit when incorporating CEQs into a surface code [34]; it reduces the length of the error detection cycle and makes the decoding process easier.

### Target Performance and Required Components

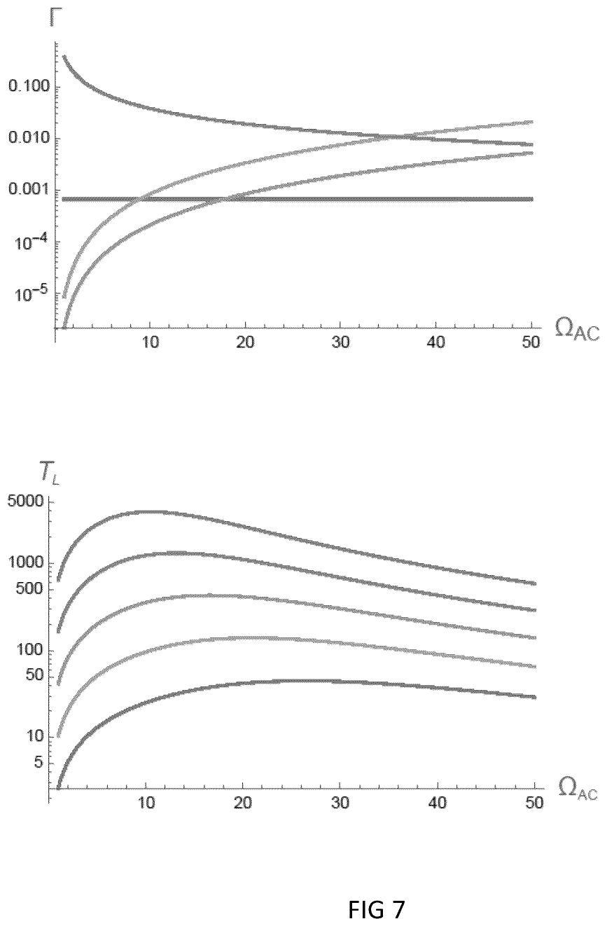

The circuit diagram for an optimized cold echo qubit is shown in FIG. 6. A future version of this device would be built using L=3 fluxonium qubits (or similar) as the base qubits, with a base coherence increase by at least a factor of 10 compared to the values in FIG. 1. In fluxoniums due to the small persistent current Γ_{z} will be further reduced (more quickly than Γₓ or Γ_{y} for a given total T₁). The mutual inductive couplings between component qubits should be fixed and not tunable since J is never reduced in the operation protocols. One could easily construct these with direct superinductances between component qubits. One could also use direct Josephson junctions for these couplings as in the ux qubit design or in the VSLQ [17], resulting in a simpler and more compact device. However, this would also necessitate an extra line to cancel unwanted flux through the loop, since the interaction now tunes with flux. Tunable mutual inductances between logical qubits will be smaller in this case but a reduction by a factor of 10 (compared to the J˜2π×1 GHz achievable in CSFQs) could still allow CZ faster than 10 ns. Given these improvements, error rates below 10⁻⁴ in all operations should be achievable, perhaps even below 10⁻⁵ as seen in FIG. 7. Note also that at smaller Ω_{AC} the device is effectively a single syndrome qubit (as the Z error rate massively dominates the others), which is beneficial for incorporation into error correction codes.

FIG. 7: L=3 predicted error rates, using the same parameters as before. On the top, error rates as in the previous figure, with T₁=2 μs (now assuming Γₓ and Γ_{z} make equal contributions) and T_{Φ}=0.5 μs. On the bottom, logical lifetime T_{L} for T₁=4T_{Φ}={2, 4, 8, 16, 32}μs. At a base coherence of just T₁=16 μs and T_{Φ}=4 μs, lifetime exceeds a millisecond.

The first purposed-designed CEQ should be the two-fuxonium circuit in the top right of Eq. 2. Optionally, the superinductor coupling the two fluxonium qubits could be replaced with a junction, at the cost of needing another flrux line to tune out stray flux in the (now nonlinear) coupling. However, this would make the loop physically much smaller, thus reducing its contribution to 1/f flux noise. One could also use capacitively shunted flux qubits, in a much smaller persistent current regime than those of the testbed.

Not shown is the readout; each fluxonium needs a tunable coupler (such as the one shown in [33]) to an associated readout resonator. Importantly, using a fixed dispersive coupling to readout will not work for the CEQ; this is because thermal fluctuations in the readout resonator state create an unprotected high frequency phase noise source, that will limit coherence once it reaches into the hundreds of μs. With such tunable couplers only a single tunable resonator is needed for readout, provided each qubit is independently coupled to it—the sum of energy shifts that results can implement majority voting for L 3, and thus significantly improve readout fidelity as well.

In an L=2 CEQ, there are thus four (or five) AC flux lines to control the primary qubit state, two flux lines and one charge line per resonator for the tunable readout, for a total of eight flux lines and two charge lines for the circuit. The “difficult” issues of realizing this version of the CEQ are thus reliably engineering superinductors (a hard engineering problem), managing flux crosstalk in the control signals, and engineering the tunable coupling to readout. Note also that with low persistent current CSFQ's [1], base coherence can easily reach the values considered in FIG. 7. While the best achieved values for CSFQ's are still substantially lower than fluxonium devices, one could still build a very high performance CEQ from them; such a device may be more physically compact as well.

### CONCLUSION

We have presented a novel small logical qubit design, called the Cold Echo Qubit, which (although not limited to such implementations) can be built entirely from conventional superconducting qubit architecture components and should exhibit remarkably high logical coherence assuming fairly modest levels of base coherence for its component flux qubits. Assuming our noise analysis is correct (or even just roughly correct), the CEQ exhibits a number of significant advantages compared to previous proposals (summarized in Table I at FIG. 8):
Single tone control: the dynamical decoupling mechanism (the \Echo″ in Cold Echo Qubit) can be engineered by driving all component qubits in a synchronized manner using just a single frequency, a much simpler signal structure than many alternatives.
Fully autonomous: no measurement or feedback is needed to operate the CEQ.
Fast gates: gates on and between CEQ's are straightforward, and given the large energy scales of the device, can be done very quickly. A single CEQ can also participate in multiple 2-CEQ gates simultaneously.
Planar circuit: the CEQ is a planar device, so can be realized in a much higher density than 3d competitors.
Single syndrome: the error model of the CEQ is very strongly biased along Z, with logical X or Y errors happening much less frequently. This is very beneficial for incorporation into digital error correction codes. Single tone control: the dynamical decoupling mechanism (the \Echo″ in Cold Echo Qubit) can be engineered by driving all component qubits in a synchronized manner using just a single frequency, a much simpler signal structure than many alternatives.

Further upgrades to this design (in its circuit, operation protocols, or both) are envisioned, but given that the simplest L=2 CEQ can demonstrate very high performance, it is an excellent candidate for near-term experimental demonstration.

From the foregoing it will be appreciated that, although specific embodiments of the disclosure have been described herein for purposes of illustration, various modifications may be made without deviating from the spirit and scope of the disclosure. Accordingly, the disclosure is not limited except as by the appended claims.

### BIBLIOGRAPHY

[1] F. Yan, S. Gustaysson, A. Kamal, J. Birenbaum, A. Sears, D. Hover, T. Gudmundsen, J. Yoder, T. Orlando, J. Clarke, et al., Nature Communications 7, 12964 (2016).
[2] H. Xiong, Q. Ficheux, A. Somoro_, L. B. Nguyen, E. Dogan, D. Rosenstock, C. Wang, K. N. Nesterov, M. G. Vavilov, and V. E. Manucharyan, Physical Review Research 4, 023040 (2022).
[3] A. Somoro_, Q. Ficheux, R. A. Mencia, H. Xiong, R. V. Kuzmin, and V. E. Manucharyan, arXiv preprint arXiv: 2103.08578 (2021).
[4] M. W. Johnson, M. H. Amin, S. Gildert, T. Lanting, F. Hamze, N. Dickson, R. Harris, A. J. Berkley, J. Johansson, P. Bunyk, et al., Nature 473, 194 (2011).
[5] J. E. Mooij, T. P. Orlando, L. Levitov, L. Tian, C. H. van der Wal, and S. Lloyd, Science 285, 1036 (2001).
[6] J. Bylander, S. Gustaysson, F. Yan, F. Yoshihara, K. Harrabi, G. Fitch, D. G. Cory, Y. Nakamura, J. S. Tsai, and W. D. Oliver, Nature Physics 7, 565 (2011).
[7] F. Yan, S. Gustaysson, J. Bylander, X. Jin, F. Yoshihara, D. G. Cory, Y. Nakamura, T. P. Orlando, and W. D. Oliver, Nature Communications 4, 2337 (2013).
[8] E. Kapit, Quantum Science and Technology 2, 033002 (2017).
[9] M. Mirrahimi, Z. Leghtas, V. V. Albert, S. Touzard, R. J. Schoelkopf, L. Jiang, and M. H. Devoret, New J. Phys. 16, 045014 (2014).
[10] J. Cohen and M. Mirrahimi, Phys. Rev. A. 90, 062344 (2014).
[11] Z. Leghtas, S. Touzard, I. M. Pop, A. Kou, B. Vlastakis, A. Petrenko, K. M. Sliwa, A. Narla, S. Shankar, M. J. Hatridge, et al., Science 347, 6224 (2015).
[12] M. H. Michael, M. Silveri, R. Brierley, V. V. Albert, J. Salmilehto, L. Jiang, and S. M. Girvin, Physical Review X 6,031006 (2016).
[13] N. Ofek, A. Petrenko, R. Heeres, P. Reinhold, Z. Leghtas, B. Vlastakis, Y. Liu, L. Frunzio, S. M. Girvin, L. Jiang, et al., Nature 536, 441 (2016).
[14] V. V. Albert, C. Shu, S. Krastanov, C. Shen, R. B. Liu, Z. B. Yang, R. J.
Schoelkopf, M. Mirrahimi, M. H. Devoret, and L. Jiang, Phys. Rev. Lett. 116, 140502 (2016).
[15] V. V. Albert, S. O. Mundhada, A. Grimm, S. Touzard, M. H. Devoret, and L. Jiang, Quantum Science and Technology 4, 035007 (2019).
[16] V. V. Albert, C. Shu, S. Krastanov, C. Shen, R. B. Liu, Z. B. Yang, R. J. Schoelkopf, M. Mirrahimi, M. H. Devoret, and L. Jiang, Physical review letters 116, 140502 (2016).
[17] E. Kapit, Phys. Rev. Lett. 116, 150501 (2016).
[18] E. Kapit, Physical review letters 120, 050503 (2018).
[19] A. Gyenis, P. S. Mundada, A. Di Paolo, T. M. Hazard, X. You, D. I. Schuster, J. Koch, A. Blais, and A. A. Houck, arXiv preprint arXiv: 1910.07542 (2019).
[20] D. Weiss, A. C. Li, D. Ferguson, and J. Koch, Physical Review B 100, 224507 (2019).
[21] A. Gyenis, A. Di Paolo, J. Koch, A. Blais, A. A. Houck, and D. I. Schuster, PRX Quantum 2, 030101 (2021).
[22] J. M. Dempster, B. Fu, D. G. Ferguson, D. Schuster, and J. Koch, Physical Review B 90, 094518 (2014).
[23] P. Groszkowski, A. Di Paolo, A. Grimsmo, A. Blais, D. Schuster, A. Houck, and J. Koch, New Journal of Physics 20, 043053 (2018).
[24] M. Abdelhafez, B. Baker, A. Gyenis, P. Mundada, A. A. Houck, D. Schuster, and J. Koch, Physical Review A 101, 022321 (2020).
[25] V. Mourik, K. Zuo, S. M. Frolov, S. Plissard, E. P. Bakkers, and L. P. Kouwenhoven, Science 336, 1003 (2012).
[26] T. D. Stanescu and S. Tewari, Journal of Physics: Condensed Matter 25, 233201 (2013).
[27] M. Deng, S. Vaitiek_enas, E. B. Hansen, J. Danon, M. Leijnse, K. Flensberg, J. Nyg_ard, P. Krogstrup, and C. M. Marcus, Science 354, 1557 (2016).
[28] O. Gul, H. Zhang, J. D. Bommer, M. W. de Moor, D. Car, S. R. Plissard, E. P. Bakkers, A. Geresdi, K. Watanabe, T. Taniguchi, et al., Nature nanotechnology 13, 192 (2018).
[29] E. Prada, P. San-Jose, M. W. de Moor, A. Geresdi, E. J. Lee, J. Klinovaja, D. Loss, J. Nyg_ard, R. Aguado, and L. P. Kouwenhoven, Nature Reviews Physics 2, 575 (2020).
[30] K. Flensberg, F. von Oppen, and A. Stern, Nature Reviews Materials 6, 944 (2021).
[31] D. R. Perez, P. Varosy, Z. Li, T. Roy, E. Kapit, and D. Schuster, arXiv preprint arXiv: 2110.11537 (2021).
[32] E. Kapit and V. Oganesyan, Quantum Science and Technology 6, 025013 (2021).
[33] J. A. Grover, J. I. Basham, A. Marakov, S. M. Disseler, R. T. Hinkey, M. Khalil, Z. A. Stegen, T. Chamberlin, W. De-Gottardi, D. J. Clarke, et al., PRX Quantum 1, 020314 (2020).
[34] A. G. Fowler, M. Mariantoni, J. M. Martinis, and A. N. Cleland, Phys. Rev. A 86, 032324 (2012).

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed description is to be regarded as illustrative in nature and not restrictive.

All references disclosed herein, whether patent or non-patent, are hereby incorporated by reference as if each was included at its citation, in its entirety. In case of conflict between reference and specification, the present specification, including definitions, will control.

Although the present disclosure has been described with a certain degree of particularity, it is understood the disclosure has been made by way of example, and changes in detail or structure may be made without departing from the spirit of the disclosure as defined in the appended claims.

1. A cold-echo qubit circuit, comprising:
a pair of fluxonium qubits; and
an inductor circuit configured to couple a first fluxonium qubit of the pair of fluxonium qubits to a second fluxonium qubit of the pair of fluxonium qubits; wherein, when driven by oscillating terms to perform parametric operations, the coupling between the pair of fluxonium qubits provided by the inductor circuit is configured to protect a quantum state defined by the pair of fluxonium qubits.

2. The cold-echo qubit circuit of claim 1, further comprising:
a third fluxonium qubit;
a second inductor circuit configured to couple the third fluxonium qubit to the first fluxonium qubit; and
a third inductor circuit configured to couple the third fluxonium qubit to the second fluxonium qubit,
wherein, when driven by the oscillating terms to perform the parametric operations, the coupling between the first, second, and third fluxonium qubits provided by the first, second, and third inductor circuits is configured to protect the quantum state defined by the first, second, and third fluxonium qubits.

3. The apparatus of claim 2, wherein quantum state may be defined based on a state of a majority of the first, second, and third fluxonium qubits.

4. The apparatus of claim 1, wherein the inductor circuit includes a superinductor.

5. The apparatus of claim 1, wherein an inductance of the inductor circuit is fixed.

6. The apparatus of claim 1, wherein the pair of fluxonium qubits includes a pair of flux qubits.

7. The apparatus of claim 1, wherein the pair of fluxonium qubits each include a qubit with double-well behavior for its states as that of a flux qubit.

8. The apparatus of claim 1, wherein the pair of fluxonium qubits each include at least one of a geometric-inductance flux qubit, a capacitively-shunted flux qubit, a double-charge quantum dot.

9. The cold-echo qubit circuit of claim 1, further comprising:
a plurality of more than two fluxonium qubits, including the pair of fluxonium qubits; and
a plurality of inductor circuits, including the inductor circuit, each configured to couple a respective pair of the plurality of more than two fluxonium qubits together; and
wherein, when driven by the oscillating terms to perform the parametric operations, the coupling between the plurality of more than two fluxonium qubits provided by the plurality of inductor circuits is configured to protect the quantum state defined by the plurality of more than two fluxonium qubits.

10. A quantum system comprising:
a first cold-echo qubit (CEQ) comprising a first pair of fluxonium qubits and a first inductor circuit loop configured to couple a first fluxonium qubit of the first pair of fluxonium qubits to a second fluxonium qubit of the first pair of fluxonium qubits;
a second CEQ comprising a second pair of fluxonium qubits and a second inductor circuit loop configured to couple a first fluxonium qubit of the second pair of fluxonium qubits to a second fluxonium qubit of the second pair of fluxonium qubits; and
a circuit element tunable by external fields coupled between first CEQ and the second CEQ and configured to facilitate multi-qubit logical gates using the first CEQ and the second CEQ.

11. The quantum computing system of claim 10, wherein the first CEQ and the second CEQ are arranged in a lattice, and are configured to be repeatedly operated on and measured by an external control circuit to enact quantum algorithms.

12. The quantum system of claim 11, wherein the first CEQ and the second CEQ are arranged into at least first and second sub-lattices of logical qubits of the lattice.

13. The quantum system of claim 11, wherein the lattice further comprises a plurality of sub-lattices, including the at least the first and second sub-lattices, having a plurality of CEQs, including the first and second CEQs.

14. The quantum system of claim 11, wherein the first CEQ is included in the first sub-lattice, the quantum system further comprising a coupling element configured to couple the first CEQ with another CEQ in the first sub-lattice.

15. The quantum system of claim 11, wherein the first CEQ is included in the first sub-lattice, the quantum system further comprising a coupling element configured to couple the first CEQ with another CEQ in the second sub-lattice.

16. The quantum system of claim 11, wherein the first CEQ is included in the first sub-lattice, the quantum system further comprising a coupling element configured to couple the first CEQ with a third CEQ in the second sub-lattice and to couple the first CEQ with a fourth CEQ in the first sub-lattice.

17. The quantum system of claim 11, wherein the first sub-lattice is configured to encode a many-qubit quantum state and the second sub-lattice is configured to perform a different function or provide error correction.

18. (canceled)

19. The quantum system of claim 11, wherein logical operations on or between component logical qubits are calibrated to form a continuous gate set.

20. The quantum system of claim 11, wherein the first sub-lattice is configured to be operated to mimic the action of a “cold” subsystem and remove errors from the many-qubit logical state.

21. The quantum system of claim 20, wherein:
the first CEQ includes a third fluxonium qubit, a third inductor loop circuit configured to couple the third fluxonium qubit to the first fluxonium qubit of the first pair of fluxonium qubits, and a fourth inductor circuit configured to couple the third fluxonium qubit to the second fluxonium qubit of the first pair of fluxonium qubits; and
the second CEQ includes a fourth fluxonium qubit, a fifth inductor loop circuit configured to couple the fourth fluxonium qubit to the first fluxonium qubit of the second pair of fluxonium qubits, and a sixth inductor circuit configured to couple the fourth fluxonium qubit to the second fluxonium qubit of the second pair of fluxonium qubits.

22. (canceled)

23. (canceled)

24. (canceled)
